(19) United States
(12) Patent Application Publication
(10) Pub. No.: US 2017/0320208 A1
(43) Pub. Date: Nov. 9, 2017

(54) Wrench Extension Assembly

(71) Applicant: Clyde Culkin, Penrose, CO (US)

(72) Inventor: Clyde Culkin, Penrose, CO (US)

(21) Appl. No.: 15/146,526

(22) Filed: May 4, 2016

(51) Int. Cl. B25G 1/00; B25G 1/10; B25G 1/04

(52) U.S. Cl. CPC B25G 1/005; B25G 1/043; B25G 1/102

(57) ABSTRACT

A wrench extension assembly includes an elongated member that has a first end, a second end and a top side. The elongated member is telescoping and includes a second section removably extendable into a first section to alter a length of the elongated member from the first end to the second end. The elongated member is straight from the first end to the second end. A first bracket is attached to the elongated member adjacent to the first end and is configured to releasably couple a wrench to the top side such that the wrench extends outwardly away from the first end. A second bracket is attached to a sleeve that is positioned on the elongated member and is slidable between the first bracket and a juncture of the first and second sections. The second bracket is configured to releasably couple the wrench to the top side.

### BACKGROUND OF THE DISCLOSURE

### Field of the Disclosure

The disclosure relates to wrench torque increasing devices and more particularly pertains to a new wrench torque increasing device for extending the effective length of a wrench to increase the torque output thereof.

### SUMMARY OF THE DISCLOSURE

An embodiment of the disclosure meets the needs presented above by generally comprising an elongated member that has a first end, a second end, a top side, a bottom side, a first lateral edge and a second lateral edge. The elongated member is telescoping and includes a first section and a second section. The second section includes the second end and is removably extendable into the first section to alter a length of the elongated member from the first end to the second end. The elongated member is straight from the first end to the second end. A first bracket is attached to the elongated member adjacent to the first end and is configured to releasably couple a wrench to the top side such that the wrench extends outwardly away from the first end. A second bracket is attached to a sleeve that is positioned on the elongated member and is slidable between the first bracket and a juncture of the first and second sections. The second bracket is configured to releasably couple the wrench to the top side.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a wrench extension assembly according to an embodiment of the disclosure.

FIG. 2 is a top view of an embodiment of the disclosure.

FIG. 3 is a bottom view of an embodiment of the disclosure.

FIG. 4 is a cross-sectional view of an embodiment of the disclosure taken along line 4-4 of FIG. 2.

FIG. 5 is an in-use perspective view of an embodiment of the disclosure.

### DESCRIPTION OF THE PREFERRED EMBODIMENT

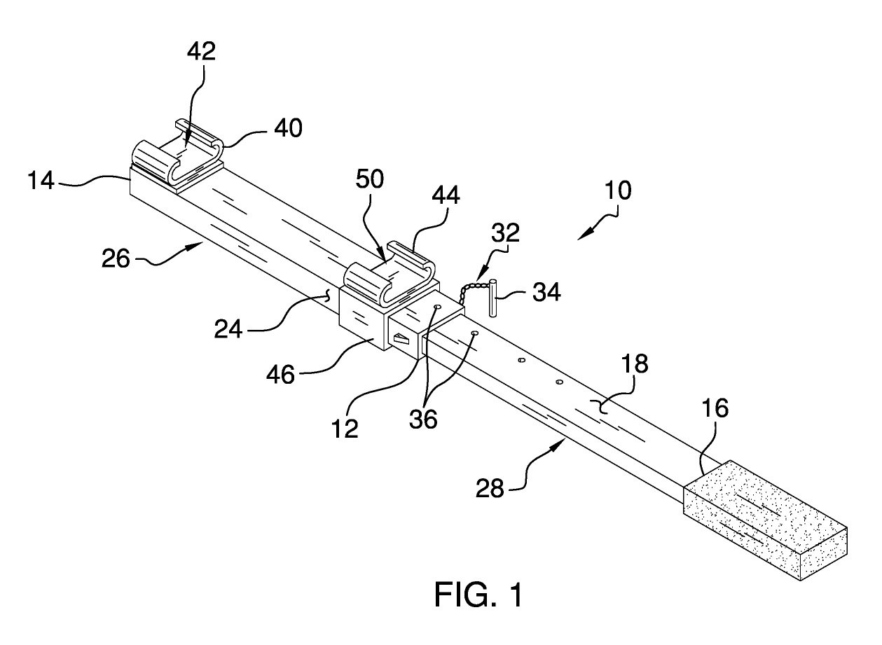

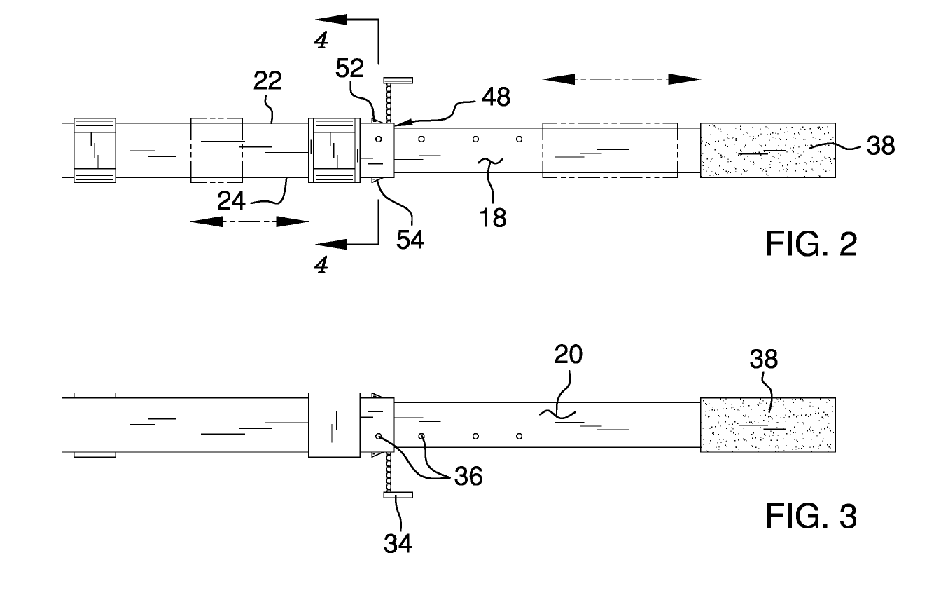

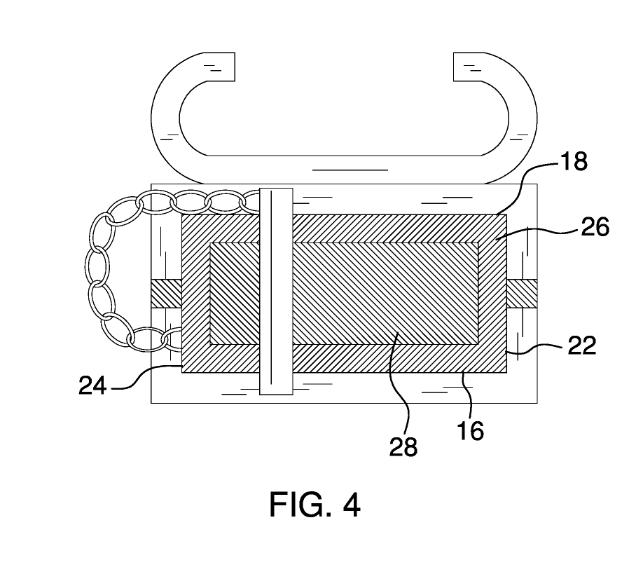

With reference now to the drawings, and in particular to FIGS. 1 through 5 thereof, a new wrench torque increasing device embodying the principles and concepts of an embodiment of the disclosure and generally designated by the reference numeral 10 will be described.

As best illustrated in FIGS. 1 through 5, the wrench extension assembly 10 generally comprises an elongated member 12 that has a first end 14, a second end 16, a top side 18, a bottom side 20, a first lateral edge 22 and a second lateral edge 24. The elongated member 12 is telescoping and includes a first section 26 and a second section 28. The second section 28 includes the second end 16 and is removably extendable into the first section 26 to alter a length of the elongated member 12 from the first end 14 to the second end 16. The elongated member 12 is straight from the first end 14 to the second end 16. A length of the elongated member 12 may vary depending on the size of a wrench 30 to be used with the assembly 10. Typically the elongated member 12 will have a smallest length being greater than 12.0 inches when the second section 28 is fully retracted into the first section 26 and a greatest length being less than 42.0 inches when the second section 28 is fully extended relative to the first section 26. A locking member 32 releasably locks the first section 26 with respect to the second section 28 to prevent movement of the first 26 and second 28 sections relative to each other. The locking member 32 may comprise a locking pin 34 removably extended through aligned apertures 36 in the first 26 and second 28 sections. A grip 38 is attached to the second end 16 of the elongated member 12 and may comprise a resiliently compressible material.

A first bracket 40 is attached to the elongated member 12 adjacent to the first end 14 and is configured to releasably couple the wrench 30 to the top side 18 such that the wrench 30 extends outwardly away from the first end 14. The first bracket 40 is non-movable with respect to the elongated member. The first bracket 40 has a C-shape and has an opening 42 therein directed upwardly from the top side 18. A second bracket 44 is attached to a sleeve 46 and the sleeve 46 is positioned on the elongated member 12 and is slidable between the first bracket 40 and a juncture 48 of the first 26 and second 28 sections to accommodate various lengths of wrenches. The second bracket 44 is configured to releasably couple the wrench 30 to the top side 18. The second bracket 44 has a C-shape and has an opening 50 therein directed upwardly from the top side 18. A stop 52 is positioned on the first section 26 adjacent to the juncture 48 of the first 26 and second 28 sections. The stop 52 prevents the sleeve 46 from being removed from the first section 26. The stop 52 is positioned on the first lateral edge 22 of the elongated member 12 and a second stop 54 may be positioned on the second lateral edge 24.

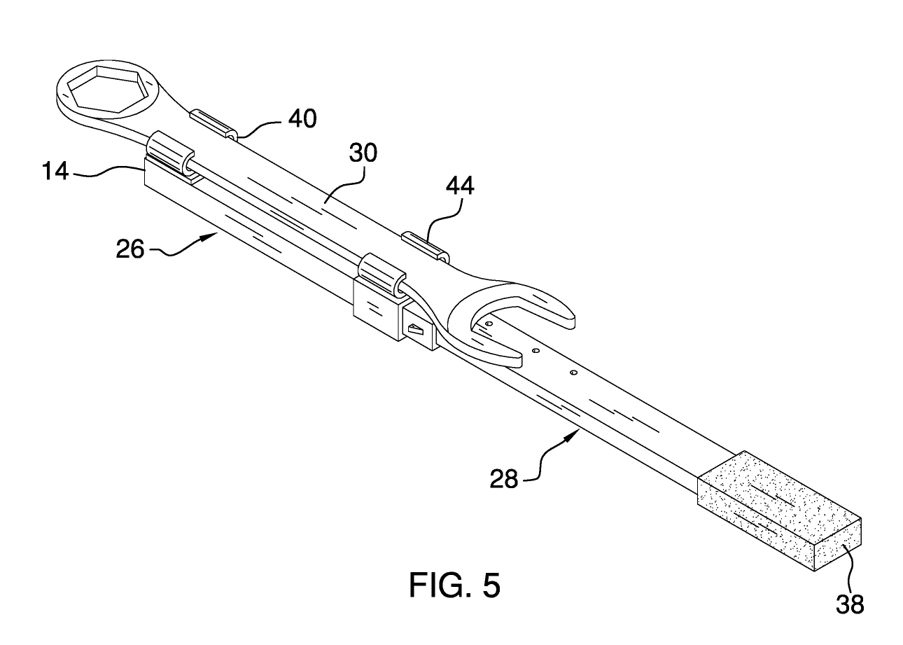

In use, a wrench 30 is placed in the openings 42, 50 in the first 40 and second 44 brackets such that the end of the wrench 30 extends beyond the first end 14 of the elongated member 12 as shown in FIG. 5. The second clamp 44 may be moved where needed to ensure that the wrench 30 properly fits on the elongated member 12. The second section 28 may be extended away from the first section 26 a selected distance based upon the amount of torque required and space allowed. The wrench 30 is then used in a conventional manner and the user grips and moves the grip 38 to increase the torque output of the wrench 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wrench extending assembly configured to engage a wrench and increase and effective length of the wrench said assembly comprising:
an elongated member having a first end, a second end, a top side, a bottom side, a first lateral edge and a second lateral edge, said elongated member being telescoping and including a first section and a second section, said second section including said second end and being removably extendable into said first section to alter a length of said elongated member from said first end to said second end, said elongated member being straight from said first end to said second end;
a first bracket being attached to said elongated member adjacent to said first end and being configured to releasably couple a wrench to said top side such that the wrench extends outwardly away from said first end; and
a second bracket being attached to a sleeve, said sleeve being positioned on said elongated member and being slidable between said first bracket and a juncture of said first and second sections, said second bracket being configured to releasably couple the wrench to said top side.

2. The wrench extending assembly according to claim 1, further including a locking member releasably locking said first section with respect to said second section to prevent movement of said first and second sections relative to each other.

3. The wrench extending assembly according to claim 1, wherein said first bracket is non-movable with respect to said elongated member.

4. The wrench extending assembly according to claim 3, wherein:
said first bracket has a C-shape and having an opening therein directed upwardly from said top side; and
said second bracket has a C-shape and having an opening therein directed upwardly from said top side.

5. The wrench extending assembly according to claim 1, further including a stop being positioned on said first section adjacent to said juncture of said first and second sections, said stop preventing said sleeve from being removed from said first section.

6. The wrench extending assembly according to claim 1, further including a grip being attached to said second end of said elongated member.

7. The wrench extending assembly according to claim 6, wherein said grip comprises an resiliently compressible material.

8. A wrench extending assembly configured to engage a wrench and increase and effective length of the wrench said assembly comprising:
an elongated member having a first end, a second end, a top side, a bottom side, a first lateral edge and a second lateral edge, said elongated member being telescoping and including a first section and a second section, said second section including said second end and being removably extendable into said first section to alter a length of said elongated member from said first end to said second end, said elongated member being straight from said first end to said second end;
a locking member releasably locking said first section with respect to said second section to prevent movement of said first and second sections relative to each other;
a first bracket being attached to said elongated member adjacent to said first end and being configured to releasably couple a wrench to said top side such that the wrench extends outwardly away from said first end, said first bracket being non-movable with respect to said elongated member, said first bracket having a C-shape and having an opening therein directed upwardly from said top side;
a second bracket being attached to a sleeve, said sleeve being positioned on said elongated member and being slidable between said first bracket and a juncture of said first and second sections, said second bracket being configured to releasably couple the wrench to said top side, said second bracket having a C-shape and having an opening therein directed upwardly from said top side;
a stop being positioned on said first section adjacent to said juncture of said first and second sections, said stop preventing said sleeve from being removed from said first section; and
a grip being attached to said second end of said elongated member, said grip comprising a resiliently compressible material.
